(19) United States
(12) Patent Application Publication
(10) Pub. No.: US 2025/0148263 A1
(43) Pub. Date: May 8, 2025

(54) Computer-implemented or hardware-implemented method of entity identification, a computer program product and an apparatus for entity identification

(71) Applicant: IntuiCell AB, Stockholm (SE)

(72) Inventors: Henrik Jörntell, Lund (SE); Linus Mårtensson, Malmö (SE)

(21) Appl. No.: 18/836,809

(22) PCT Filed: Feb. 8, 2023
(86) PCT No.: PCT/SE2023/050104

§ 371 Date: Aug. 8, 2024

(30) Foreign Application Priority Data
Feb. 11, 2022 (SE) 2250135-7

(51) Int. Cl. G06N 3/045

(52) U.S. Cl. CPC G06N 3/045

(57) ABSTRACT

The disclosure relates to a data processing system (100), configured to have one or more system input(s) (110a, 110b, . . . , 110z) comprising data to be processed and a system output (120), comprising: a first network, NW, (130) comprising a plurality of first nodes (130a, 130b, . . . , 130x), each first node configured to have a plurality of inputs (132a, 132b, . . . , 132y), at least one of the plurality of inputs being a system input, and configured to produce an output (134a, 134b, . . . , 134x); a second NW (140) comprising first and second sets (146, 148) of second nodes (140a, 140b, . . . , 140u), each second node being configured to have an output (134a, 134b, . . . , 134x) of one or more first nodes (130a, 130b, . . . , 130x) as input(s) (142a, 142b, . . . , 142u) and configured to produce an output (144a, 144b, . . . , 144u), wherein the system output (120) comprises the outputs (134a, 134b, . . . , 134x) of each first node (130a, 130b, . . . , 130x); and wherein the output (144a) of a second node (140a) of the first set (146) of nodes (140a) is utilized as an input to one or more processing units (136a3, 136b1), each processing unit (136a3, 136b1) being configured to provide negative feedback to a respective first node (130a, 130b); and/or wherein the output (144) of a second node (140u) of the second set (148) of nodes (140b, . . . , 140u) is utilized as an input to one or more processing units (136x3), each processing unit being configured to provide positive feedback to a respective first node (130x). The disclosure further relates to a second NW, a method, and a computer program product.

### TECHNICAL FIELD

The present disclosure relates to a data processing system comprising first and second networks, a second network connectable to a first network, a method, and a computer program product. More specifically, the disclosure relates to a data processing system comprising first and second networks, a second network connectable to a first network, a method and a computer program product as defined in the introductory parts of the independent claims.

### BACKGROUND ART

Artificial intelligence (AI) is known. However, today's AI models are typically trained to do only one thing. Thus, the AI systems are often trained from scratch, in other words, trained from a zero knowledge baseline, for each new problem. Moreover, learning each new task often takes a fairly long time. In addition, learning requires a large amount of training data, e.g., as every new task is learnt from scratch. Furthermore, most of today's models process just one modality of information at a time. They can take in e.g., text, or images or speech, but typically not all three at the same time. In addition, most of today's models are not able to handle abstract forms of data. Most of today's models also have a fairly high energy consumption.

Therefore, there may be a need for an AI system that can handle many separate tasks. Furthermore, there may be a need for an AI system that utilizes existing skills to learn new tasks faster and more effectively. Moreover, there may be a need for an AI system, which requires only a limited amount of training data. There may be a need for an AI system which enables multimodal models that encompass different modalities, such as vision, auditory, and language understanding simultaneously. Furthermore, there may be a need for an AI system which perform new, more complex tasks. Moreover, there may be a need for an AI system which generalizes across tasks. There may be a need for an AI system which handles more abstract forms of data. Furthermore, there may be a need for an AI system which is sparse and efficient and still utilizes all relevant information, thus enabling a more energy efficient data processing. Preferably, such AI systems provide or enable one or more of improved performance, higher reliability, increased efficiency, faster training, use of less computer power, use of less training data, use of less storage space, less complexity and/or use of less energy.

Google Pathways (https://www.searchenginejournal.com/google-pathways-ai/428864/#close) mitigates some of the above-mentioned problems to some extent. However, there may still be a need for more efficient AI systems and/or alternative approaches.

### SUMMARY

The present disclosure seeks to mitigate, alleviate, or eliminate one or more of the above-identified deficiencies and disadvantages in the prior art, for example, by seeking to solve at least the above-mentioned problem(s) and limitations of known AI systems. According to a first aspect there is provided a data processing system. The data processing system is configured to have one or more system input(s) comprising data to be processed and a system output. The data processing system comprises a first network (NW) comprising a plurality of first nodes, each first node being configured to have a plurality of inputs, at least one of the plurality of inputs being a system input, and configured to produce an output. Furthermore, the data processing system comprises a second NW comprising first and second sets of second nodes, each second node being configured to have an output of one or more first nodes as input(s) and configured to produce an output. Moreover, the system output comprises the outputs of each first node. The output of a second node of the first set of nodes is utilized as an input to one or more processing units, each processing unit being configured to provide negative feedback to a respective first node; and/or the output of a second node of the second set of nodes is utilized as an input to one or more processing unit, each processing unit being configured to provide positive feedback to a respective first node. By providing negative and/or positive feedback from nodes of the second network to the first network, the context/task at hand can be more accurately and/or efficiently processed by utilizing only or predominantly the nodes (of the first network) that are best suited for processing data for that particular context/task. Hence, a more efficient data processing system, which can handle a wider range of contexts/tasks per the given amount of network resources, and thus reduced power consumption is achieved.

According to some embodiments, each of the plurality of first nodes comprises a processing unit for each of the plurality of inputs, and each processing unit comprises an amplifier and a leaky integrator having a time constant.

According to some embodiments, the time constant for processing units having the output of a node of the first or second sets of nodes as an input is larger, than the time constant for other processing units. By setting the time constant for processing units impacted by a node of the second network (a node of the first or second sets of nodes) to be larger than the time constant for other processing units, e.g., processing units impacted by a system input, better/improved dynamic performance, and therefore higher reliability, of the data processing system is achieved, e.g., by providing a smoother transition from one context/task to another and/or avoiding/reducing flipflopping/oscillations between a first processing mode associated with a first context/task and a second processing mode associated with a second (different) context/task.

According to some embodiments, the output of each node of the first and/or second sets of nodes is inhibited while the data processing system is in a learning mode.

According to some embodiments, each processing unit comprises an inhibiting unit configured to inhibit the output of each node of the first and/or second sets of nodes while the data processing system is in the learning mode.

According to some embodiments, each node of the first and second sets of nodes comprises an enabling unit, wherein each enabling unit is directly connected to the output of the respective node, and wherein the enabling unit(s) is configured to inhibit the output while the data processing system is in the learning mode.

According to some embodiments, the data processing system comprises a comparing unit, and the comparing unit is configured to compare the system output to an adaptive threshold while the data processing system is in the learning mode.

According to some embodiments, the output of each node of the first or second sets of nodes is inhibited only when the system output is larger than the adaptive threshold.

According to some embodiments, the system input(s) comprises sensor data of a plurality of contexts/tasks.

According to some embodiments, the data processing system is configured to learn from the sensor data to identify one or more entities while in a learning mode and thereafter configured to identify the one or more entities while in a performance mode.

According to some embodiments, the identified entity is one or more of a speaker, a spoken letter, syllable, phoneme, word or phrase present in the sensor data or an object or a feature of an object present in sensor data or a new contact event, the end of a contact event, a gesture or an applied pressure present in the sensor data.

According to some embodiments, the data processing system is configured to learn from sensor data to identify one or more (previously unidentified) entities or a measurable characteristic (or measurable characteristics) thereof while in a learning mode and thereafter configured to identify the one or more entities or a measurable characteristic (or measurable characteristics) thereof while in a performance mode, e.g., from newly acquired sensor data not included in the corpus of sensor data the data processing system originally learnt from. Such sensor data may include fused sensor data of one or more types, for example, audio and visual data feeds may be fused from an audio sensor and an image sensor. In some embodiments, this allows both visual and audible characteristics for example of a talking image of a human entity to be used for entity identification.

In some embodiments, depending on the level of meta-data which is used for learning in the training data, entities may be a identified in more than one way, for example, they may be identified a type of entity, a classification or a category of entity, or as an individual entity. in other words, an object may be recognized as a “car” or as a particular brand, color or body style of car, or as an individual car having a particular registration number. An entity may be an object or as an organism, for example, a human or animal or part thereof.

Some applications of the data processing system may include, but are not limited to, processing images of tissue samples to categories cells or microorganisms, determining drugs and medications and doses for individual patient treatments and/or therapies for personalized medication and the like. However, a large range of other contexts of use of the data processing system are possible and embodiments may be useful for areas as diverse as, for example, facial recognition and biometric security, dynamic spectrum allocation in wireless networks, and robotics.

According to some embodiments, each input of the second nodes is a weighted version of an output of the one or more first nodes.

According to some embodiments, learning while in the learning mode and/or updating of weights for the first and/or the second networks is based on correlation.

According to a second aspect there is provided a second network, NW, connectable to a first NW, the first NW comprising a plurality of first nodes, each first node being configured to have a plurality of inputs and configured to produce an output. The second NW comprises first and second sets of second nodes, each second node being configurable to have an output of one or more first nodes as input(s) and configured to produce an output. The output of a node of the first set of nodes is utilized as an input to one or more processing units, each processing unit being configured to provide negative feedback to a respective first node of the first NW; and/or the output of a node of the second set of nodes is utilized as an input to one or more processing units, each processing unit being configured to provide positive feedback to a respective first node.

According to a third aspect there is provided a computer-implemented or hardware-implemented method for processing data. The method comprises receiving one or more system input(s) comprising data to be processed; providing a plurality of inputs, at least one of the plurality of inputs being a system input to a first network, NW, comprising a plurality of first nodes; receiving an output from each first node; providing a system output comprising the output of each first node; providing the output of each first node to a second NW comprising first and second sets of second nodes; receiving output of each second node. Furthermore, the method comprises utilizing the output of a second node of the first set of nodes as an input to one or more processing units, each processing unit being configured to provide negative feedback to a respective first node; and/or utilizing the output of a second node of the second set of nodes as an input to one or more processing units, each processing unit being configured to provide positive feedback to a respective first node.

According to a fourth aspect there is provided a computer program product comprising a non-transitory computer readable medium, having stored thereon a computer program comprising program instructions, the computer program being loadable into a data processing unit and configured to cause execution of the method of the third aspect or any of the above mentioned embodiments when the computer program is run by the data processing unit.

Effects and features of the second, third and fourth aspects are to a large extent analogous to those described above in connection with the first aspect and vice versa. Embodiments mentioned in relation to the first aspect are largely compatible with the second, third and fourth aspects and vice versa.

An advantage of some embodiments is a more efficient processing of the data/information, especially during a learning/training mode. For example, as the training from one training context, in other words on one data corpus can be transferred to a greater or lesser degree to other new training contexts, the training phase for new training contexts can be greatly reduced and/or may utilise a smaller corpus of training data than might otherwise be required.

Another advantage of some embodiments is that the system/network is less complex, e.g., having fewer nodes (with the same precision and/or for the same context/input range).

Yet another advantage of some embodiments is a more efficient use of data.

A further advantage of some embodiments is that the system/network is able to handle a larger/wider input range and/or a larger context range (for the same size of the system/network, e.g., same number of nodes, and/or with the same precision).

Yet a further advantage of some embodiments is that the system/network is more efficient and/or that training/learning is shorter/faster.

Another advantage of some embodiments is that a network with lower complexity is provided.

A further advantage of some embodiments is an improved/increased generalization (e.g., across different tasks/contexts).

Yet a further advantage of some embodiments is that the system/network is less sensitive to noise.

Yet another advantage of some embodiments is that the system/network is able to learn new tasks/contexts faster and more effectively.

Yet another advantage of some embodiments is that the system/network may enable multimodal identification that encompass vision, auditory, and language understanding simultaneously.

Yet another advantage of some embodiments is that the system/network is able to handle more abstract forms of data.

Yet another advantage of some embodiments is that the system/network can be “sparsely” activated, thus it is faster and more energy efficient, while still being accurate.

Yet another advantage of some embodiments is that the system/network understands/interprets different types (or modalities) of data more efficiently.

Other advantages of some of the embodiments are improved performance, higher/increased reliability, increased precision, increased efficiency (for training and/or performance), faster/shorter training/learning, less computer power needed, less training data needed, less storage space needed, less complexity and/or lower energy consumption.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic block diagram illustrating a data processing system according to some embodiments;

FIG. 2 is a schematic block diagram illustrating a second network according to some embodiments;

FIG. 3 is a flowchart illustrating method steps according to some embodiments; and

FIG. 4 is a schematic drawing illustrating an example computer readable medium according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a “node”. The term “node” may refer to a neuron, such as a neuron of an artificial neural network, another processing element, such as a processor, of a network of processing elements or a combination thereof. Thus, the term “network” (NW) may refer to an artificial neural network, a network of processing elements or a combination thereof.

Below is referred to a “processing unit”. A processing unit may also be referred to as a synapse, such as an input unit (with a processing unit) for a node. However, in some embodiments, the processing unit is a (general) processing unit (other than a synapse) associated with (connected to, connectable to or comprised in) a node of a NW (such as a first or a second NW), or a (general) processing unit located between a node of a first NW and a node of a second NW.

Below is referred to “negative feedback”. Negative feedback (or balancing feedback) is or occurs when some function of an output, such as the output of a second NW, is fed back (in a feedback loop) in a manner that tends to reduce the amplitude of and/or fluctuations in the output, i.e., the (total) loop gain (of the feedback loop) is negative.

Below is referred to “positive feedback” (or exacerbating feedback) is or occurs when some function of an output, such as the output of a second NW, is fed back (in a feedback loop) in a manner that tends to increase the amplitude of and/or fluctuations in the output, i.e., the (total) loop gain (of the feedback loop) is positive.

Below is referred to a “leaky integrator” (LI). An LI is a component having an input, taking/calculating the integral of the input (and providing the calculated integral as an output), and gradually leaking a small amount of the input over time (thereby reducing the output over time).

Below is referred to “context”. A context is the circumstances involved or the situation. Context relates to what type of (input) data is expected, e.g., different types of tasks, where every different task has its own context. As an example, if a system input is pixels from an image sensor, and the image sensor is exposed to different lighting conditions, each different lighting condition may be a different context for an object, such as a ball, a car, or a tree, imaged by the image sensor. As another example, if the system input is audio frequency bands from one or more microphones, each different speaker may be a different context for a phoneme present in one or more of the audio frequency bands.

Below is referred to “measurable”. The term “measurable” is to be interpreted as something that can be measured or detected, i.e., is detectable. The terms “measure” and “sense” are to be interpreted as synonyms.

Below is referred to “entity”. The term entity is to be interpreted as an entity, such as physical entity or a more abstract entity, such as a financial entity, e.g., one or more financial data sets. The term “physical entity” is to be interpreted as an entity that has physical existence, such as an object, a feature (of an object), a gesture, an applied pressure, a speaker, a spoken letter, a syllable, a phoneme, a word, or a phrase.

One of the ideas behind the present invention is a system/network, in which all nodes are activated, but only some of them to a greater extent (or only some of the nodes are activated) for each particular context/task. Furthermore, during learning/training the system/network dynamically learns which parts (nodes) of the network are good at which contexts/tasks. Thus, the system/network has a larger capacity to learn a variety of contexts/tasks and/or modalities, while being faster to train and more energy efficient (e.g., as the entire network is not activated for each context/task/modality). As each node in principle can contribute to each task, although to a different relative degree, the skills learnt from one task may be utilized while learning other tasks. This to make the learning more generalizable across different tasks.

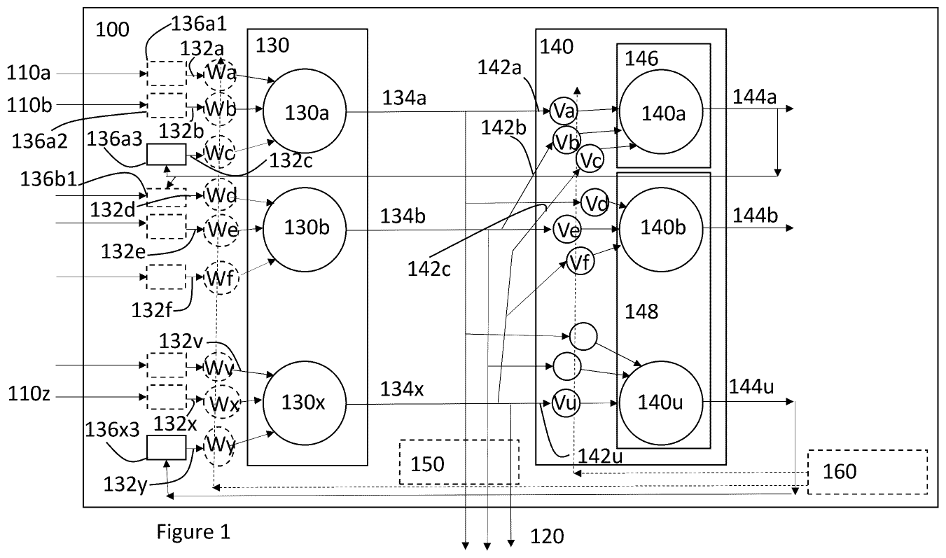

In the following, embodiments will be described where FIG. 1 is a schematic block diagram illustrating a data processing system 100 according to some embodiments. In some embodiments, the data processing system 100 is a network or comprises a first and a second network. In some embodiments, the data processing system 100 is a deep neural network, a deep belief network, a deep reinforcement learning system, a recurrent neural network, or a convolutional neural network.

The data processing system 100 has, or is configured to have, one or more system input(s) 110a, 110b, . . . , 110z. The one or more system input(s) 110a, 110b, . . . , 110z comprises data to be processed. The data may be multidimensional. E.g., a plurality of signals is provided in parallel. In some embodiments, the system input 110a, 110b, . . . , 110z comprises or consists of time-continuous data. In some embodiments, the data to be processed comprises data from sensors, such as image sensors, touch sensors and/or sound sensors (e.g., microphones). Furthermore, in some embodiments, the system input(s) comprises sensor data of a plurality of contexts/tasks, e.g., while the data processing system 100 is in a learning mode and/or while the data processing system 100 is in a performance mode.

Furthermore, the data processing system 100 has, or is configured to have, a system output 120. The data processing system 100 comprises a first network (NW) 130. The first NW 130 comprises a plurality of first nodes 130a, 130b, . . . , 130x. Each first node 130a, 130b, . . . , 130x has, or is configured to have, a plurality of inputs 132a, 132b, . . . , 132y. At least one of the plurality of inputs 132a, 132b, . . . , 132y is a system input 110a, 110b, . . . , 110z. In some embodiments, all of the system inputs 110a, 110b, . . . , 110z are utilized as inputs 132a, 132b, . . . , 132y to one or more of the first nodes 130a, 130b, . . . , 130x. Moreover, in some embodiments, each of the first nodes 130a, 130b, . . . , 130x has one or more system inputs 110a, 110b, . . . , 110z as input(s) 132a, 132b, . . . , 132y. Furthermore, the first NW 130 produces, or is configured to produce, an output 134a, 134b, . . . , 134x. In some embodiments, each first node 130a, 130b, . . . , 130x calculates a combination, such as a (linear) sum, a squared sum, or an average, of the inputs 132a, 132b, . . . , 132y (to that node) multiplied by first weights Wa, Wb, . . . , Wy to produce the output 134a, 134b, . . . , 134x. Moreover, the data processing system 100 comprises a second NW 140. The second NW 140 comprises a first set 146 of second nodes 140a. Furthermore, the second NW 140 comprises a second set 148 of second nodes 140b, . . . , 140u. Each second node 140a, 140b, . . . , 140u has, or is configured to have, an output 134a, 134b, . . . , 134x of one or more first nodes 130a, 130b, . . . , 130x as input(s) 142a, 142b, . . . , 142u. In some embodiments, each second node 140a, 140b, . . . , 140u has, or is configured to have, all the outputs 134a, 134b, . . . , 134x of the first node(s) 130a, 130b, . . . , 130x as input(s) 142a, 142b, . . . , 142u. Moreover, each second node 140a, 140b, . . . , 140u produces, or is configured to produce an output 144a, 144b, . . . , 144u. In some embodiments, each second node 140a, 140b, . . . , 140u calculates a combination, such as a (linear) sum, a squared sum, or an average, of its inputs 142a, 142b, . . . , 142u multiplied by second weights Va, Vb, . . . , Vu to produce the output 144a, 144b, . . . , 144u. The system output 120 comprises the outputs 134a, 134b, . . . , 134x of each first node 130a, 130b, . . . , 130x. In some embodiments, the system output 120 is an array of the outputs 134a, 134b, . . . , 134x of each first node 130a, 130b, . . . , 130x. Furthermore, the output 144a of a (or each) second node 140a of the first set 146 of nodes 140a is utilized as an input to one or more processing units 136a3, 136b1, each processing unit 136a3, 136b1 being configured to provide negative feedback to a respective first node 130a, 130b. In some embodiments, the negative feedback is provided as a direct input 132c, 132d (weighted with a respective weight Wc, Wd) and/or as a linear or (frequency-dependent) non-linear gain control (e.g., gain reduction) of other inputs 132a, 132b, 132e, 132f (not shown). I.e., in some embodiments, the processing units 136a3, 136b1 are not separate inputs to the one or more nodes 130a, 130b, but instead controls (e.g., reduces) the gain of other inputs 132a, 132b, 132e, 132f of the one or more nodes 130a, 130b, e.g., via adjustments of the first weights Wa, Wb (associated with the one or more nodes 130a, 130b) or by controlling the gain of an amplifier associated with the input 132a, 132b, 132e, 132f. Additionally, or alternatively, the output 144b, . . . , 144u of a/each second node 140b, . . . , 140u of the second set 148 of nodes 140b, . . . , 140u is utilized as an input to one or more processing units 136x3, each processing unit being configured to provide positive feedback to a respective first node 130x. In some embodiments, the positive feedback is provided as a direct input 132y (weighted with a respective weight Wy) and/or as a linear or (frequency-dependent) non-linear gain control (e.g., gain increase) of other inputs 132v, 132x (not shown in the figure). I.e., in some embodiments, the processing unit 136x3 is not a separate input to the one or more nodes 130x, but instead controls (e.g., increases) the gain of other inputs 132v, 132x of the one or more nodes 130x, e.g., via adjustments of the first weights Wv, Wx (associated with the one or more nodes 130x) or by controlling the gain of an amplifier associated with the input 132v, 132x. By providing negative and/or positive feedback from nodes of the second network to the first network, the context/task at hand can be more accurately and/or efficiently processed by utilizing only or predominantly the nodes (of the first network) that are best suited for processing data for that particular context/task. Hence, a more efficient data processing system, which can handle a wider range of contexts/tasks, and thus reduced power consumption is achieved.

In some embodiments, each of the plurality of first nodes 130a, 130b, . . . , 130x comprises a processing unit 136a1, 136a2, . . . , 136x3 for each of the plurality of inputs 132a, 132b, . . . , 132y. Each processing unit 136a1, 136a2, . . . , 136x3 comprises an amplifier and a leaky integrator (LI) having a time constant A1, A2. The equation for each LI is of the form dX/dt=−Ax+C, where C is the input and A is the time constant, i.e., the rate of the leak. The time constant A1 for the LIs of the processing units 136a3, 136b1, . . . , 136x3 having the output of a node of the first or second sets 146, 148 of nodes 140a, . . . , 140u as an input is larger, such as at least 10 times larger, preferably at least 50 times larger, more preferably at least 100 times larger, than the time constant A2 for the LIs of (all) the other processing units 136a1, 136a2, . . . (e.g., all the processing units processing a system input). By A1 being larger than A2, the context may be clarified or emphasized, i.e., by setting the time constant for processing units impacted by a node of the second network (a node of the first or second sets of nodes) to be larger than the time constant for other processing units, e.g., processing units impacted by a system input, better/improved dynamic performance, and therefore higher reliability, of the data processing system is achieved, e.g., by providing a smoother transition from one context/task to another and/or avoiding/reducing flipflopping/oscillations between a first processing mode associated with a first context/task and a second processing mode associated with a second (different) context/task.

In some embodiments, the output 144a, 144b, . . . , 144u of one or more, such as each, node of the first and/or second sets of nodes 146, 148 is inhibited while the data processing system is in a learning mode. Furthermore, in some embodiments, each processing unit 136a1, 136a2, . . . , 136x3 comprises an inhibiting unit. Each inhibiting unit is configured to inhibit the output 144a, 144b, . . . , 144u of the respective node 140a, 140b, . . . , 140u of the first and/or second set of nodes 146, 148 (at least part of the time) while the data processing system is in the learning mode. The inhibiting unit may inhibit the output 144a, 144b, . . . , 144u by setting the gain of the amplifier (of the processing unit it is comprised in) to zero or by setting the output (of the processing unit it is comprised in) to zero. Alternatively, or additionally, each node 140a, 140b, . . . , 140u of the first and second sets of nodes 146, 148 comprises an enabling unit, wherein each enabling unit is directly connected to the output 144a, 144b, . . . , 144u of the respective node 140a, 140b, . . . , 140u. Each enabling unit is configured to inhibit (or enable) the output 144a, 144b, . . . , 144u (at least part of the time) while the data processing system is in the learning mode. The enabling unit may inhibit the output 144a, 144b, . . . , 144u by setting the output 144a, 144b, . . . , 144u to zero. In some embodiments, the data processing system 100 comprises a comparing unit 150. The comparing unit 150 is configured to compare the system output 120 to an adaptive threshold, e.g., while the data processing system 100 is in the learning mode. In these embodiments, the output 144a, . . . , 144u of each node 140a, 140b, . . . , 140u of the first or second sets of nodes 146, 148 is inhibited only when the system output 120 is larger than the adaptive threshold. In some embodiments, the inhibiting unit and/or the enabling unit is provided with information, such as a flag, about the result of the comparison between the system output 120 and the adaptive threshold. Furthermore, in some embodiments, comparing the system output 120 to an adaptive threshold comprises comparing an average value of the activity of each first node 130a, . . . , 130x, e.g., the output 134a, 134b, . . . , 134x of each first node 130a, 130b, . . . , 130x, to the adaptive threshold. Alternatively, or additionally, comparing the system output 120 to an adaptive threshold comprises comparing the activity, e.g., the output 134a, 134b, . . . , 134x, (or the average of the activity) of one or more specific first nodes 130b to the adaptive threshold. Furthermore, alternatively, or additionally, comparing the system output 120 to an adaptive threshold comprises comparing the activity, e.g., the output 134a, 134b, . . . , 134x, of every first node 130a, 130b, . . . , 130x to the adaptive threshold. Moreover, in some embodiments, the adaptive threshold is a set of adaptive thresholds, one adaptive threshold for each (or each of the one or more specific) first node 130a, 130b, . . . , 130x. In some embodiments, the adaptive threshold is adapted based on a total energy/activity/level of all the system inputs 110a, 110b, . . . , 110z or of all the inputs 132a, 132b, . . . , 132y to the first nodes 130a, 130b, . . . , 130x. As an example, the higher the total energy of the (system) input is, the higher the threshold (level) is set. Additionally, or alternatively, at the beginning of the learning mode the threshold (level) is higher than at the end of the learning mode.

In some embodiments, the data processing system 100 is configured to from the sensor data learn to identify one or more (previously unidentified) entities or a measurable characteristic (or measurable characteristics) thereof while in a learning mode and thereafter configured to identify the one or more entities or a measurable characteristic (or measurable characteristics) thereof while in a performance mode, e.g., from sensor data. In some embodiments, the identified entity is one or more of a speaker, a spoken letter, syllable, phoneme, word, or phrase present in the (audio) sensor data or an object or a feature of an object present in sensor data (e.g., pixels) or a new contact event, the end of a contact event, a gesture or an applied pressure present in the (touch) sensor data. Although, in some embodiments, all the sensor data is a specific type of sensor data, such as audio sensor data, image sensor data or touch sensor data, in other embodiments, the sensor data is a mix of different types of sensor data, such as audio sensor data, image sensor data and touch sensor data, i.e., the sensor data comprises different modalities. In some embodiments, the data processing system 100 is configured to from the sensor data learn to identify a measurable characteristic (or measurable characteristics) of an entity. A measurable characteristic may be a feature of an object, a part of a feature, a temporally evolving trajectory of positions, a trajectory of applied pressures, or a frequency signature or a temporally evolving frequency signature of a certain speaker when speaking a certain letter, syllable, phoneme, word, or phrase. Such a measurable characteristic may then be mapped to an entity. For example, a feature of an object may be mapped to an object, a part of a feature may be mapped to a feature (of an object), a trajectory of positions may be mapped to a gesture, a trajectory of applied pressures may be mapped to a (largest) applied pressure, a frequency signature of a certain speaker may be mapped to the speaker, and a spoken letter, syllable, phoneme, word or phrase may be mapped to an actual letter, syllable, phoneme, word or phrase. Such mapping may simply be a look up in a memory, a look up table or a database. The look up may be based on finding the entity of a plurality of physical entities that has the characteristic, which is closest to the measurable characteristic identified. From such a look up, the actual entity may be identified, e.g., the unidentified entity is identified as an entity of the plurality of entities with stored one or more characteristics which have closest match to the one or more identified characteristics. By utilizing the method described herein for identifying one or more unidentified entities or a measurable characteristic (or measurable characteristics) thereof, an improved performance of entity identification is achieved, a more reliable entity identification is provided, a more efficient method of identifying an entity is provided and/or a more energy efficient method of identifying an entity is provided, e.g., since the method saves computer power and/or storage space.

In some embodiments, each input 142a, 142b, . . . , 142u of the second nodes 140a, 140b, . . . , 140u is a weighted version of an output 134a, 134b, . . . , 134x of the one or more first nodes 130a, 130b, . . . , 130x. Furthermore, in some embodiments, each of the second nodes 140a, 140b, . . . , 140u comprises a (second) processing unit (not shown) for each of the plurality of inputs 142a, 142b, . . . , 142u. In these embodiments, each of the plurality of inputs 142a, 142b, . . . , 142u may be processed by a respective (second) processing unit, e.g., before being weighted by a respective second weight Va, Vb, . . . , Vu.

In some embodiments, learning while in the learning mode and/or updating of weights Wa, Wb, . . . , Wy, Va, Vb, . . . , Vu for the first and/or the second networks 130, 140 is based on correlation, e.g., correlation between each respective input 142a, . . . , 142c to a node 140a and the combined activity of all inputs 142a, . . . , 142c to that node 140a, i.e., correlation between each respective input 142a, . . . , 142c to a node 140a and the output 144a of that node 140a (as an example for the node 140a and applicable to all other nodes 130b, . . . 130x, 140a, . . . , 140u).

In order for the system to learn in the learning mode, updating of weights Wa, Wb, . . . , Wy, Va, Vb, . . . , Vu for the first and/or the second networks 130, 140 may be performed. To this end, the data processing system 100 may comprise an updating/learning unit 160. In some embodiments, the negative and positive feedback loops from the second network 140 back to the first network 130 can occur with fixed weights, i.e., the first weights Wa, Wb, . . . , Wy are fixed (e.g., has been set to fixed values in a first step based on correlation), whereas the weights of the connections from the first network 130 to the second network 140, i.e., the second weights Va, Vb, . . . , Vu, are modifiable by correlation-based learning. This contributes, for a given context, to identify which of the nodes 130a, 130b, . . . , 130x that provide related information (e.g., important information for that context) and then help these specific nodes (i.e., the nodes providing important information for that context) to cooperatively increase each other's activity/output for that context (by means of positive feedback). At the same time, these cooperative nodes will also through correlation-based learning in the negative feedback loop nodes automatically identify other nodes which provides the least related information (e.g., not important information) for that context and through the negative feedback suppress the activity in (e.g., the output of) these nodes. For another context, it may be the case that another subset of nodes, which may be only partly overlapping the previous subset of nodes, provide related information and then they can learn to cooperatively increase or amplify each other's activity for that context (and suppress the activity of other nodes providing less related information for that context). This contributes to generating a first (data processing) network 130 in which many nodes learn to participate across many different contexts, although with different (relative) specializations. The connections from the first network 130 to the second network 140 may learn while the first network 130 is not in a learning mode, or the second network 140 may learn simultaneously with learning in the first network 130. I.e., the second weights Va, Vb, . . . , Vu may be updated/modified during a second learning mode, in which the first weights Wa, Wb, . . . , Wy are fixed (e.g., after a first learning mode, in which the first weights Wa, Wb, . . . , Wy were updated/modified/set). In some embodiments, the first and second learning modes are repeated, e.g., a number of times, such as 2, 3, 4, 5 or 10 times, i.e., an iteration of the first and second learning modes may be performed. Alternatively, both the first weights Wa, Wb, . . . , Wy and the second weights Va, Vb, . . . , Vu are updated/modified during the learning mode. In some embodiments, the data processing system 100 comprises an updating/learning unit 160 for the updating, combining and/or correlation. In some embodiments, the updating/learning unit 160 has the system output 120 (or a desired system output) directly as an input. Alternatively, the updating/learning unit 160 has the output of the comparing unit 150 as input. Alternatively, or additionally, the updating/learning unit 160 has a state/value of each respective first weight Wa, Wb, . . . , Wy and/or second weight Va, Vb, . . . , Vu as an input. In some embodiments, the updating/learning unit 160 applies a correlation learning rule to an actual (or a desired) output and inputs of a (each) first node 130a, 130b, . . . , 130x and/or a (each) second node 140a, 140b, . . . , 140u in order to find a differential weight(s) to apply to the weight(s) Wa, Wb, . . . , Wy, Va, Vb, . . . , Vu (for updating). In some embodiments, the updating/learning unit 160 produces an update signal(s) (e.g., comprising the differential weights), which is utilized to update each respective first weight Wa, Wb, . . . , Wy and/or each respective second weight Va, Vb, . . . , Vu. In some embodiments, the data processing system 100 comprises a first updating/learning unit configured to update each respective first weight Wa, Wb, . . . , Wy and a second updating/learning unit configured to update each respective second weight Va, Vb, . . . , Vu. In some embodiments, the learning is based on correlation, i.e., a first node (e.g., 130a) that do not correlate with the activity, e.g., the output (e.g., 144a), of a particular second node (e.g., 140a) will gradually have the second weight (e.g., Va) associated with the connection between that particular first node (e.g., 130a) and that particular second node (e.g., 140a) decreased, whereas a first node (e.g., 130b) that correlate with the activity, e.g., the output (e.g., 144a), of a second node (e.g., 140a) will gradually have the second weight (e.g., Vb) associated with the connection between that particular first node (e.g., 130b) and that particular second node (e.g., 140a) increased. Once, the learning mode is completed, in some embodiments, the first and second weights Wa, Wb, . . . , Wy, Va, Vb, . . . , Vu are not updated, e.g., during the performance mode.

In some embodiments, a first node 130a comprises a plurality of processing units 136a1, . . . , 136a3 configured to provide negative feedback and/or a plurality of processing units 136a1, . . . , 136a3 configured to provide positive feedback. Thus, a first node 130a, 130b, . . . , 130x may have multiple processing units providing negative feedback and multiple processing units providing positive feedback (although no processing unit can provide both negative and positive feedback). In these embodiments, the negative/positive feedback may be provided as a weighted direct input 132c and the first weights Wa, Wb, Wc associated with (connected to) the processing units 136a1, . . . , 136a3 may be different from each other.

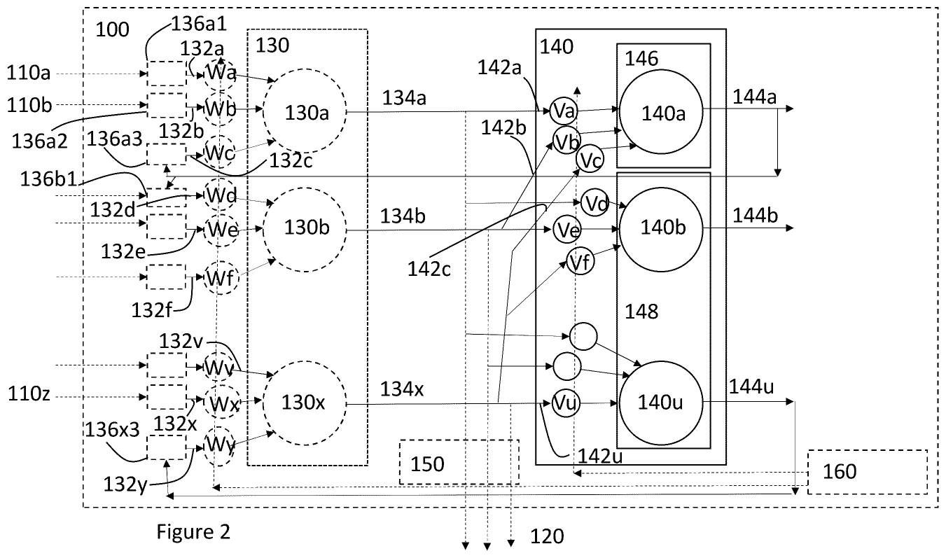

FIG. 2 illustrates a second network 140 according to some embodiments. The second network, NW, 140 is connectable to a first NW 130, the first NW 130 comprises a plurality of first nodes 130a, 130b, . . . , 130x. Each first node 130a, 130b, . . . , 130x has, or is configured to have, a plurality of inputs 132a, 132b, . . . , 132x. Furthermore, each first node 130a, 130b, . . . , 130x produces, or is configured to produce, an output 134a, 134b, . . . , 134x. Moreover, each first node 130a, 130b, . . . , 130x comprises at least one processing unit 136a3, . . . , 136x3. The second NW 140 comprises first and second sets 146, 148 of second nodes 140a, 140b, . . . , 140u. Each second node 140a, 140b, . . . , 140u is configurable to have an output 134a, 134b, . . . , 134x of one or more first nodes 130a, 130b, . . . , 130x as input(s) 142a, 142b, . . . , 142u. Furthermore, each second node 140a, 140b, . . . , 140u produces, or is configured to produce, an output 144a, 144b, . . . , 144u. The output 144a of a/each second node 140a of the first set 146 of nodes 140a is utilizable as an input to one or more processing units 136a3, each processing unit 136a3 providing, or being configured to provide, negative feedback to a respective first node 130a (of the first NW 130). Additionally, or alternatively, the output 144u of a/each second node 140u of the second set 148 of nodes 140b, . . . , 140u is utilizable as an input to one or more processing units 136x3, each processing unit 136x3 providing, or being configured to provide, positive feedback to a respective first node 130x (of the first NW 130). The second NW 140 may be utilized to increase the capacity of the first NW 130 (or make the first NW more efficient), e.g., by identifying an apparent (present) context of the first NW 130 (and facilitating adaptation of the first NW 130 according to the identified context).

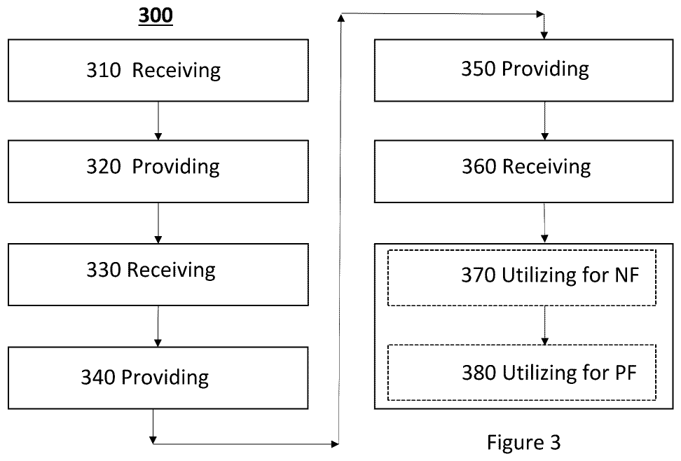

FIG. 3 is a flowchart illustrating example method steps according to some embodiments. FIG. 3 shows a computer-implemented or hardware-implemented method 300 for processing data. The method may be implemented in analog hardware/electronics circuit, in digital circuits, e.g., gates and flipflops, in mixed signal circuits, in software and in any combination thereof. The method comprises receiving 310 one or more system input(s) 110a, 110b, . . . , 110z comprising data to be processed. Furthermore, the method 300 comprises providing 320 a plurality of inputs 132a, 132b, . . . , 132y, at least one of the plurality of inputs being a system input, to a first network, NW, (30) comprising a plurality of first nodes 130a, 130b, . . . , 130x. Moreover, the method 300 comprises receiving 330 an output 134a, 134b, . . . , 134x from/of each first node 130a, 130b, . . . , 130x. The method 300 comprises providing 340 a system output 120. The system output 120 comprises the output 134a, 134b, . . . , 134x of each first node 130a, 130b, . . . , 130x. Furthermore, the method 300 comprises providing 350 the output 134a, 134b, . . . , 134x of each first node 130a, 130b, . . . , 130x to a second NW 140. The second NW 140 comprises first and second sets 146, 148 of second nodes 140a, 140b, . . . , 140u. Moreover, the method 300 comprises receiving 360 output 144a, 144b, . . . , 144u of each second nodes 140a, 140b, . . . , 140u. The method 300 comprises utilizing 370 the output 144a of a/each second node 140a of the first set 146 of nodes 140a as an input to one or more processing unit(s) 136a3, each processing unit 136a3 being configured to provide negative feedback to a respective node 130a of the first NW 130 (based on the input). Additionally, or alternatively, the method 300 comprises utilizing 380 the output 144u of a/each second node 140u of the second set 148 of nodes 140b, . . . , 140u as an input to one or more processing unit(s) 136x3, each processing unit being configured to provide positive feedback to a respective node 130x of the first NW 130 (based on the input). In some embodiments, the steps 310-380 are repeated until a stop condition is met. A stop condition may be that all data to be processed have been processed or that a specific amount of data/number of loops have been processed/performed.

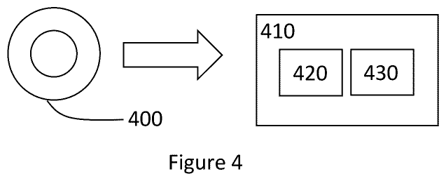

According to some embodiments, a computer program product comprises a non-transitory computer readable medium 400 such as, for example a universal serial bus (USB) memory, a plug-in card, an embedded drive, a digital versatile disc (DVD) or a read only memory (ROM). FIG. 4 illustrates an example computer readable medium in the form of a compact disc (CD) ROM 400. The computer readable medium has stored thereon, a computer program comprising program instructions. The computer program is loadable into a data processor (PROC) 420, which may, for example, be comprised in a computer or a computing device 410. When loaded into the data processing unit, the computer program may be stored in a memory (MEM) 430 associated with or comprised in the data-processing unit. According to some embodiments, the computer program may, when loaded into and run by the data processing unit, cause execution of method steps according to, for example, the method illustrated in FIG. 3, which is described herein.

The person skilled in the art realizes that the present disclosure is not limited to the preferred embodiments described above. The person skilled in the art further realizes that modifications and variations are possible within the scope of the appended claims. For example, signals from other sensors, such as aroma sensors or flavor sensors may be processed by the data processing system. Moreover, the data processing system described may equally well be utilized for unsegmented, connected handwriting recognition, speech recognition, speaker recognition and anomaly detection in network traffic or intrusion detection systems, IDSs. Additionally, variations to the disclosed embodiments can be understood and effected by the skilled person in practicing the claimed disclosure, from a study of the drawings, the disclosure, and the appended claims.

1. A data processing system (100), configured to have one or more system input(s) (110a, 110b, . . . , 110z) comprising data to be processed and a system output (120), comprising:
a first network, (130) comprising a plurality of first nodes (130a, 130b, . . . , 130x), each first node configured to have a plurality of inputs (132a, 132b, . . . , 132y), at least one of the plurality of inputs being a system input, and configured to produce an output (134a, 134b, . . . , 134x);
a second network (140) comprising first and second sets (146, 148) of second nodes (140a, 140b, . . . , 140u), each second node being configured to have an output (134a, 134b, . . . , 134x) of one or more first nodes (130a, 130b, . . . , 130x) as input(s) (142a, 142b, . . . , 142u) and configured to produce an output (144a, 144b, . . . , 144u);
wherein the system output (120) comprises the outputs (134a, 134b, . . . , 134x) of each first node (130a, 130b, . . . , 130x); and
wherein the output (144a) of a second node (140a) of the first set (146) of nodes (140a) is utilized as an input to one or more processing units (136a3, 136b1), each processing unit (136a3, 136b1) being configured to provide negative feedback to a respective first node (130a, 130b), and/or wherein the output (144) of a second node (140u) of the second set (148) of nodes (140b, . . . , 140u) is utilized as an input to one or more processing units (136x3), each processing unit being configured to provide positive feedback to a respective first node (130x).

2. The data processing system of claim 1, wherein each of the plurality of first nodes (130a, 130b, . . . , 130x) comprises a processing unit (136a1, 136a2, . . . , 136x3) for each of the plurality of inputs (132a, 132b, . . . , 132y), wherein each processing unit (136a1, 136a2, . . . , 136x3) comprises an amplifier and a leaky integrator having a time constant (A1, A2), and wherein the time constant (A1) for processing units (136a3, . . . , 136x3) having the output of a node of the first or second sets (146, 148) of nodes (140a, . . . , 140u) as an input is larger, than the time constant (A2) for other processing units.

3. The data processing system of claim 1, wherein the output (144a, 144b, . . . , 144u) of each node of the first and/or second sets of nodes (146, 148) is inhibited while the data processing system (100) is in a learning mode.

4. The data processing system of claim 1, wherein each processing unit comprises an inhibiting unit configured to inhibit the output (144a, 144b, . . . , 144u) of each node of the first and/or second sets of nodes (146, 148) while the data processing system is in the learning mode.

5. The data processing system of claim 1, wherein each node (140a, 140b, . . . , 140u) of the first and second sets of nodes (146, 148) comprises an enabling unit, wherein each enabling unit is directly connected to the output (144a, 144b, . . . , 144u) of the respective node (140a, 140b, . . . , 140u), and wherein the enabling unit(s) is configured to inhibit the output (144a, 144b, . . . , 144u) while the data processing system is in the learning mode.

6. The data processing system of claim 3, wherein the data processing system (100) comprises a comparing unit (150), and wherein the comparing unit (150) is configured to compare the system output (140) to an adaptive threshold while the data processing system (100) is in the learning mode, and wherein the output (144a, . . . , 144u) of each node (140a, 140b, . . . , 140u) of the first or second sets of nodes (146, 148) is inhibited only when the system output (140) is larger than the adaptive threshold.

7. The data processing system of claim 1, wherein the system input(s) comprises sensor data of a plurality of contexts/tasks.

8. The data processing system of claim 1, wherein the data processing system is configured to from the sensor data learn to identify one or more entities while in a learning mode and thereafter configured to identify the one or more entities while in a performance mode and wherein the identified entity is one or more of a speaker, a spoken letter, syllable, phoneme, word or phrase present in the sensor data or an object or a feature of an object present in sensor data or a new contact event, an end of a contact event, a gesture or an applied pressure present in the sensor data.

9. The data processing system of claim 1, wherein each input (142a, 142b, . . . , 142u) of the second nodes (140a, 140b, . . . , 140u) is a weighted version of an output (134a, 134b, . . . , 134x) of the one or more first nodes (130a, 130b, . . . , 130x).

10. The data processing system of claim 3, wherein learning while in the learning mode and/or updating of weights for the first and/or the second networks (130, 140) is based on correlation.

11. A second network, (140) connectable to a first network (130), the first network (130) comprising a plurality of first nodes (130a, 130b, . . . , 130x), each first node (130a, 130b, . . . , 130x) configured to have a plurality of inputs (132a, 132b, . . . , 132x), configured to produce an output (134a, 134b, . . . , 134x) and comprising at least one processing unit 136a3, . . . , 136x3, the second network (140) comprising;
first and second sets (146, 148) of second nodes (140a, 140b, . . . , 140u), each second node (140a, 140b, . . . , 140u) being configurable to have an output (134a, 134b, . . . , 134x) of one or more first nodes (130a, 130b, . . . , 130x) as input(s) (142a, 142b, . . . , 142u) and configured to produce an output (144a, 144b, . . . , 144u); and
wherein the output (144a) of a second node (140a) of the first set (146) of nodes (140a) is utilizable as an input to one or more processing units (136a3, 136b1), each processing unit (136a3, 136b1) being configured to provide negative feedback to a respective first node (130a, 130b), and/or wherein the output (144u) of a second node (140u) of the second set (148) of nodes (140b, . . . , 140u) is utilizable as an input to one or more processing units (136x3), each processing unit being configured to provide positive feedback to a respective first node (130x).

12. A computer-implemented or hardware-implemented method (300) for processing data, comprising:
receiving (310) one or more system input(s) (110a, 110b, . . . , 110z) comprising data to be processed;
providing (320) a plurality of inputs (132a, 132b, . . . , 132y), at least one of the plurality of inputs being a system input, to a first network, (130) comprising a plurality of first nodes (130a, 130b, . . . , 130x);
receiving (330) an output (134a, 134b, . . . , 134x) from each first node (130a, 130b, 130x);
providing (340) a system output (120), comprising the output (134a, 134b, . . . , 134x) of each first node (130a, 130b, . . . , 130x);
providing (350) the output (134a, 134b, . . . , 134x) of each first node (130a, 130b, . . . , 130x) to a second network (140) comprising first and second sets (146, 148) of second nodes (140a, 140b, . . . , 140u);
receiving (360) output (144a, 144b, . . . , 144u) of each second nodes (140a, 140b, . . . , 140u); and
utilizing (370) the output (144a) of a second node (140a) of the first set (146) of nodes (140a) as an input to one or more processing units (136a3, 136b1), each processing unit (136a3, 136b1) being configured to provide negative feedback to a respective first node (130a, 130b); and/or
utilizing (380) the output (144) of a second node (140u) of the second set (148) of nodes (140b, . . . , 140u) as an input to one or more processing units (136x3), each processing unit (136x3) being configured to provide positive feedback to a respective first node (130x).

13. A computer program product comprising a non-transitory computer readable medium (400), having stored thereon a computer program comprising program instructions, the computer program being loadable into a data processing unit (420) and configured to cause execution of the method according to claim 1 when the computer program is run by the data processing unit (420).
